(19) United States
(12) Patent Application Publication
(10) Pub. No.: US 2011/0191973 A1
(43) Pub. Date: Aug. 11, 2011

(54) BATH BRUSH AND MANUFACTURING METHOD THEREOF

(76) Inventor: Shu-Han CHEN, Pei Tou (TW)

(21) Appl. No.: 12/702,256

(22) Filed: Feb. 8, 2010

(51) Int. Cl. A47K 7/02; B23P 17/04

(52) U.S. Cl. 15/210.1; 29/428

(57) ABSTRACT

The present invention provides a bath brush, which includes a handle and at least two ball-shaped elastic bath mesh materials. The handle is formed with at least two installation holes arranged along a length of the handle. Each of the bath mesh materials has two spongy semispherical bodies and a pass-through section connected the two semispherical bodies. The pass-through section of each of the bath mesh materials is directly positioned in one of the installation holes of the handle with the two semispherical bodies respectively positioned on a front face and a rear face of the handle. The elastic bath mesh materials are directly secured to the handle of themselves without using any fixing member. Therefore, the production rate of the bath brush can be increased and the manufacturing cost of the bath brush can be lowered without wasting resource.

### FIELD OF THE INVENTION

The present invention relates generally to a sanitary product, and more particularly to a bath brush made from elastic bath mesh materials and a handle.

### BACKGROUND OF THE INVENTION

Bath products are daily necessities in modern life. U.S. Pat. No. 6,092,258 discloses a bath brush 10. The bath brush 10 has a handle 14, an elastic mesh tube 12 and a binding member such as a tie string 16. The handle 14 is formed with multiple perforations 44, 46, 48. The tie string 16 is passed through the elastic mesh tube 12 and the perforations 44, 46, 48 to fix the elastic mesh tube 12 on a front face of the handle 14.

In the conventional bath brush, it is necessary to use the tie string 16 to bind the elastic mesh tube 12 on the handle. Such fixing process leads to low production rate so that the manufacturing cost be hardly lowered. Moreover, for having bath mesh materials on both the front face and the rear face of the bath brush, it is necessary to dispose two elastic mesh tubes 12 on the front and rear faces of the bath brush respectively. In accordance to such configuration, the tie string must be passed through the perforations of the handle and both the elastic mesh tubes. As a result, it is quite difficult and time-consuming to manufacture the bath brush.

In addition, the conventional bath brush is simply made of a bath mesh material with one single color. Therefore, the appearance of the bath brush is monotonous without attraction.

### SUMMARY OF THE INVENTION

It is therefore a primary object of the present invention to provide a bath brush including a handle and several elastic bath mesh materials installed thereon. The connection structure between the elastic bath mesh materials and the handle is simplified and the production rate is increased.

It is a further object of the present invention to provide the above bath brush. After a manufacturing process of the bath brush is completed, the bath mesh materials are formed on a front face and a rear face of the bath brush at the same time.

It is still a further object of the present invention to provide the above bath brush, in which the bath mesh materials have more versatile colors.

To achieve the above and other objects, the bath brush of the present invention includes a handle and at least two elastic bath mesh materials. The handle is formed with at least two installation holes arranged along a length of the handle. The number of the elastic bath mesh materials is at least equal to that of the installation holes. The bath mesh materials are ball-shaped. Each of the bath mesh materials has two spongy semispherical bodies and a pass-through section connected between the two semispherical bodies.

The elastic bath mesh materials are directly installed on the handle. The pass-through section of each of bath mesh materials is directly positioned in the installation hole with the two semispherical bodies respectively positioned on the front and rear faces of the handle.

Whereby the bath mesh material is directly secured to the handle of itself without using any fixing member. The semispherical bodies have a size much larger than the diameter of the installation hole. Therefore, the semispherical bodies are hindered from passing through the installation hole,

The bath mesh materials of the bath brush can selectively have different colors to enliven and beautify the appearance of the bath brush.

The present invention can be best understood through the following description and accompanying drawings, wherein:

### BRIEF DESCRIPTION OF THE DRAWINGS

FIG. 1 is a perspective view of a preferred embodiment of the present invention;

FIG. 2 is a perspective exploded view of the handle and the elastic plastic mesh tube of the preferred embodiment of the present invention, in which the plastic mesh tube is not yet installed on the handle to form the elastic bath mesh material;

FIG. 3 is a sectional view taken along line 3-3 of FIG. 1;

FIG. 4 is a sectional view taken along line 4-4 of FIG. 3;

FIG. 5 shows a manufacturing method of the present invention;

FIG. 6 is a top view according to FIG. 5;

FIG. 7 is a perspective view of the handle of another preferred embodiment of the present invention;

FIG. 8 shows another manufacturing method of the present invention; and

FIG. 9 shows still another manufacturing method of the present invention.

### DETAILED DESCRIPTION OF THE PREFERRED EMBODIMENTS

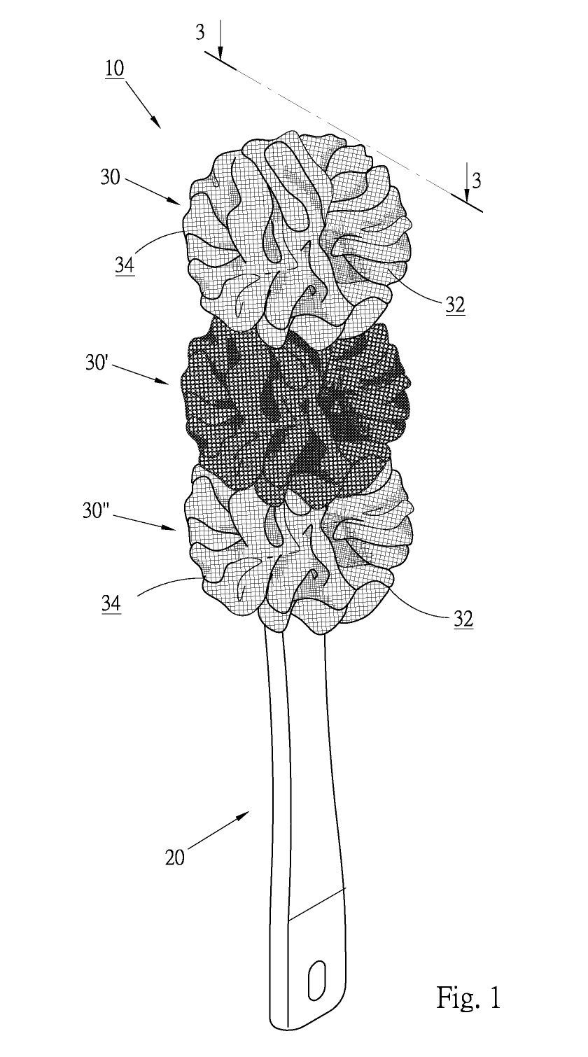

Please refer to FIG. 1. According to a preferred embodiment, the bath brush 10 of the present invention includes a handle 20 and multiple ball-like elastic bath mesh materials 30 installed on the handle.

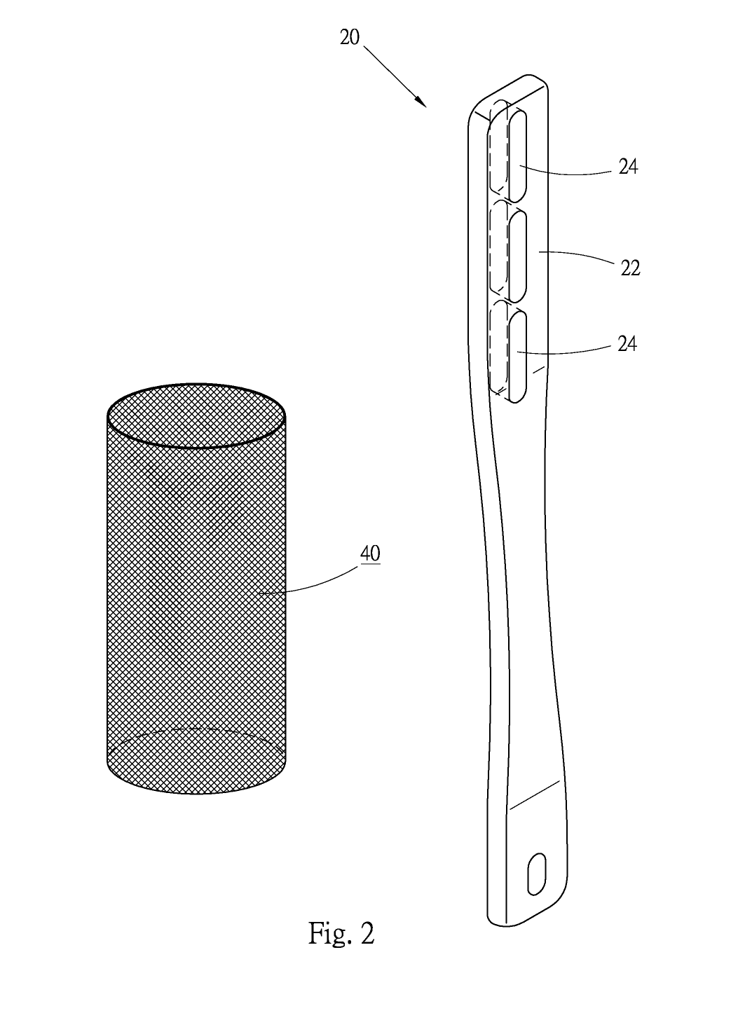

Referring to FIG. 2, the handle 20 is an elongated body. The handle 20 has a front half section as an installation section 22 for installing the elastic bath mesh materials 30 thereon and a rear half section for a user to hold. The installation section 22 of the handle is formed with at least two installation holes 24 one after another arranged along a length of the handle. In this embodiment, each installation hole 24 is an elongated hole with a length several times a width thereof.

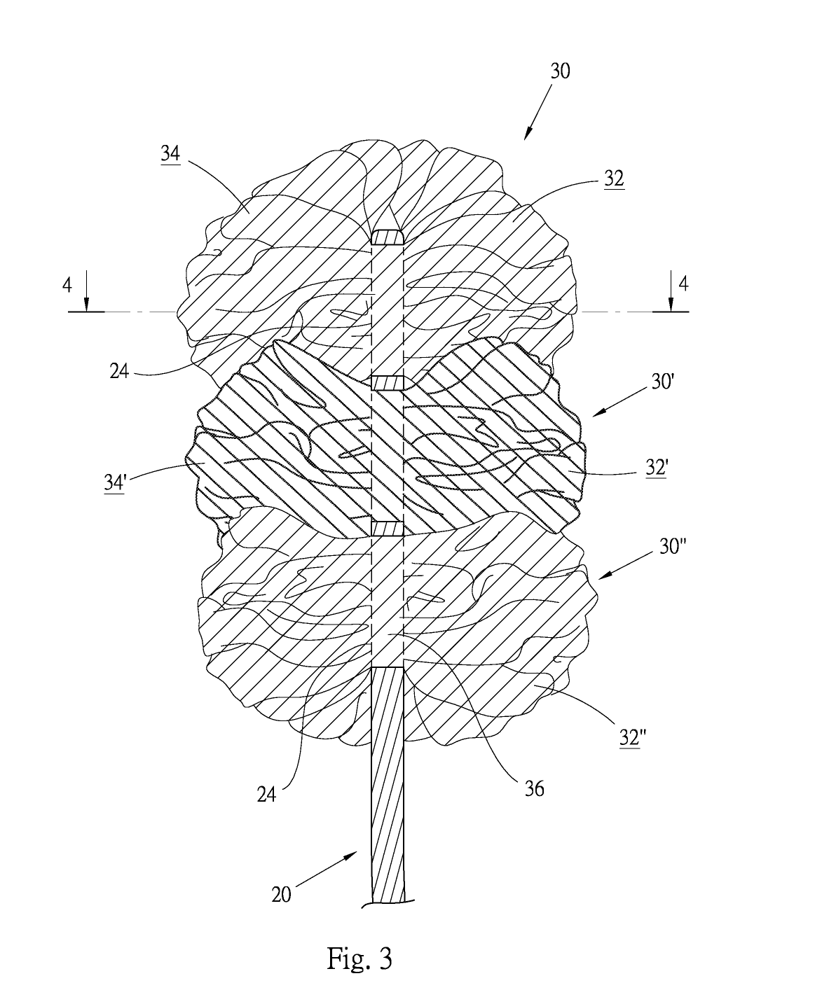

The number of the elastic bath mesh materials 30 is at least equal to that of the installation holes 24. In this embodiment, there are three bath mesh materials and three installation holes. The spongy bath mesh materials 30 are made of the elastic plastic mesh tubes 40 as shown in FIG. 2. The plastic mesh tubes 40 used in the present invention are elastic and flexible. The plastic mesh tubes are tubular elastic meshes made of plastic materials and are elastically extensible and flexible, which can be made of recyclable and decomposable environment protection materials. In this embodiment, each bath mesh material 30 is installed in one of the installation holes 24. The bath mesh materials 30 are directly fixed on the handle 20 of themselves without using any fixing member or tie member. Referring to FIG. 3, each bath mesh material has two semispherical bodies 32, 34 and a pass-through section 36 connected between the two semispherical bodies.

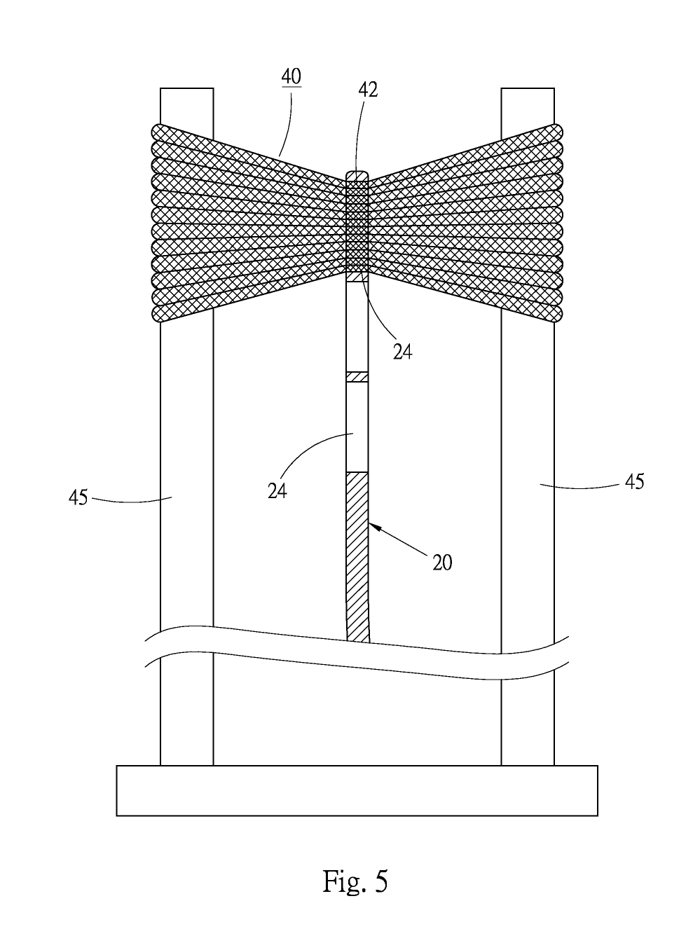

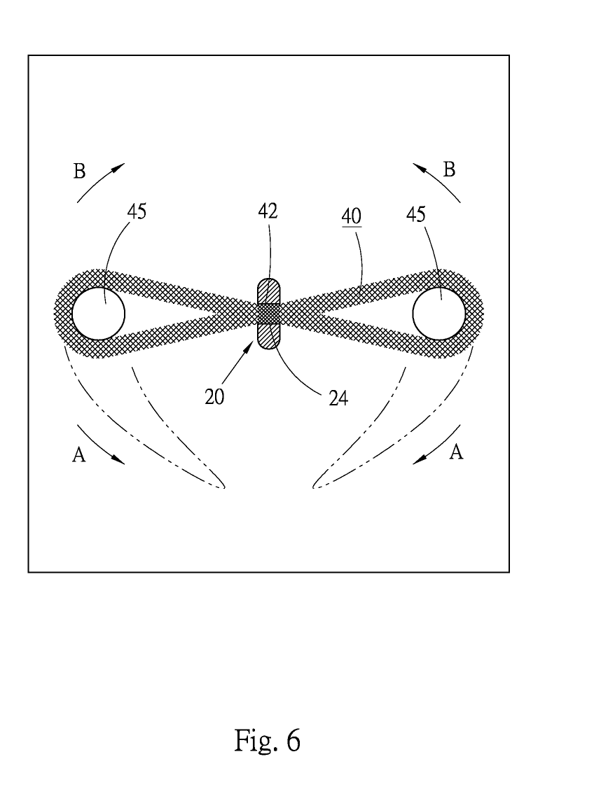

The manufacturing process of the present invention is described as follows: First, an elastic plastic mesh tube 40 with a certain length is prepared. Then, referring to FIGS. 5 and 6, the plastic mesh tube 40 is passed through one installation hole 24 of the handle 20 and two sides of the mesh tube 40 are fitted on two posts 45 of a manufacturing apparatus. The mesh tube 40 is fitted on the posts 45 in a crimped state and elastically extended by the posts 45 in a radial direction. A section of the mesh tube 40, which is positioned in the installation hole 24, serves as a pass-through portion 42. Two sides of the mesh tube 40 are respectively positioned on a front face and a rear face of the handle. The pass-through portion 42 is preferably a middle section of the mesh tube as shown in FIG. 5, whereby two sides of the mesh tube have even volume. Since the mesh tube is elastic, the pass-through portion 42 can slightly tightly and elastically contact a wall of the installation hole 24. In other words, the pass-through portion of the mesh tube is slightly compressed within the installation hole.

Then, two sides of the mesh tube 40 are gradually pulled out from top ends of the posts 45 in direction A or direction B as shown in FIG. 6. The way of pulling out the mesh tube is shown as U.S. Pat. No. 5,709,434. After the mesh tube 40 is released from the extended state, the mesh tube 40 will become a ball-shaped bath mesh material 30 with numerous randomly formed crimps/folds/ruffles. After the mesh tube 40 is totally pulled out from the posts, the ball-shaped bath mesh material 30 is installed on the handle as shown in FIG. 1.

Then a second and a third plastic mesh tubes are passed through the other two installation holes respectively and the above steps are repeated to form a second and a third bath mesh materials 30′ , 30″.

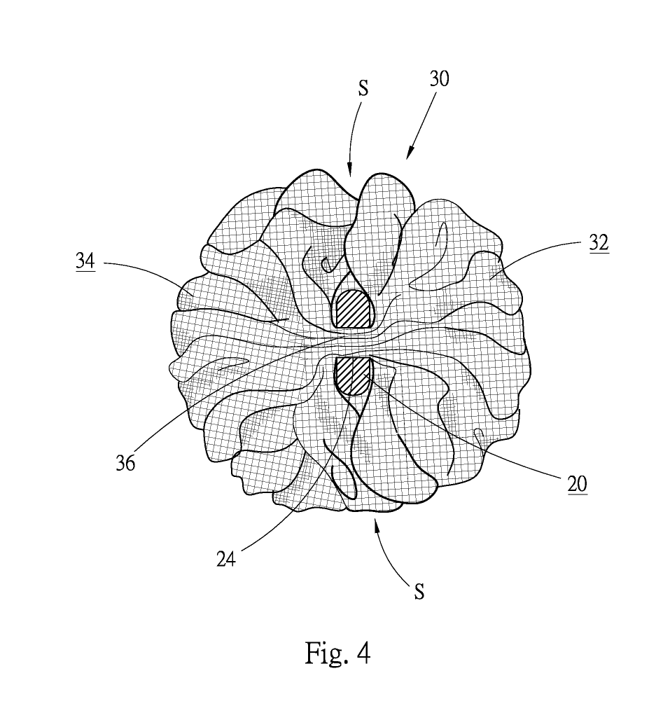

Please now refer to FIGS. 3 and 4. After the above manufacturing process is completed, the spongy semispherical bodies 32, 34 of each bath mesh material 30 are respectively positioned on the front and rear faces of the handle 20 to form a complete spherical body. Referring to FIG. 4, the semispherical bodies 32, 34 have a diameter several times the width of the handle with lateral sides (portions S) of the semispherical bodies 32, 34 in contact with each other. Accordingly, the two semispherical bodies 32, 34 together enclose the handle 20. The pass-through section 36 of the mesh material 30 is connected between the two semispherical bodies 32, 34 in a bundled state. The pass-through section 36 is exactly the aforesaid pass-through portion 42 passed through the installation hole 24. The spongy semispherical bodies 32, 34 have a size much larger than the width or diameter of the installation hole 24, whereby the spongy semispherical bodies 32, 34 are not liable to slip through the installation hole. Therefore, the bath mesh material 30 is securely fixed on the handle and hindered from detaching therefrom.

The multiple bath mesh materials are one after another arranged along the length of the handle in contact with each other without any gap between each two adjacent bath mesh materials. Therefore, as shown in FIGS. 1 and 3, the mesh materials 30 together form an elongated soft bath means along the length of the handle, and cover two sides of the handle, in addition, a top of the handle is enclosed in the uppermost mesh material 30 (as shown in FIG. 1). Accordingly, the front half section of the handle is enclosed and hidden in the mesh materials without being exposed to the exterior side.

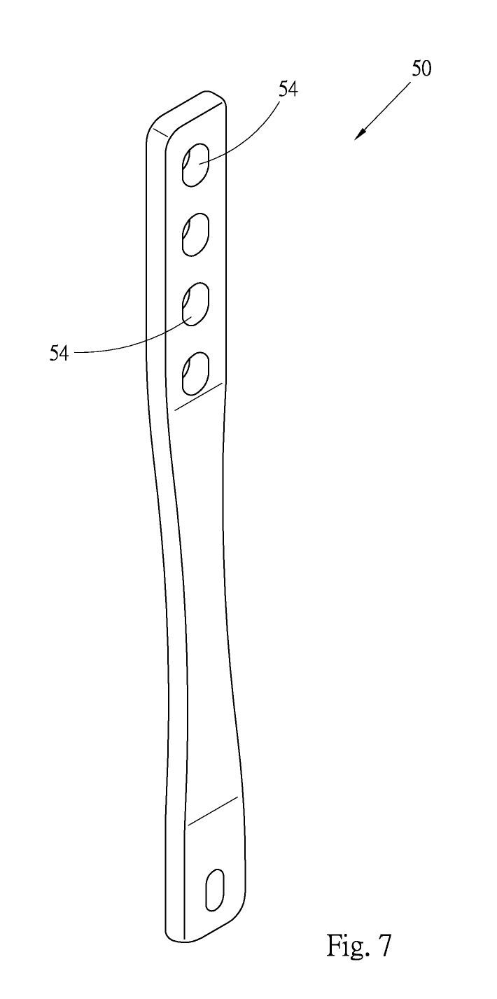

The configuration of the installation holes of the handle is not limited to the elongated holes as shown in the first embodiment. Alternatively, the installation holes of the handle can have other different configurations. For example, the installation holes can be circular holes, elliptic holes or polygonal holes. FIG. 7 shows a second embodiment of the present invention, in which the handle 50 is formed with circular or elliptic installation holes.

In the bath brush of the present invention, the elastic bath mesh materials 30 are directly fixed on the handle of themselves without using any fixing member such as tie string or fastener. The bath mesh materials 30 are secured to the handle of themselves and not liable to detach from the handle. The bath mesh material possessed of anti-detachment mechanism results for the prevention of separation.

Accordingly, the fixing process of the bath mesh materials of the present invention is simplified and free from the troublesome tying operation of the fixing member. Therefore, the production rate of the bath brush can be increased and the manufacturing cost thereof can be lowered. Especially, in the conventional bath brush, for having plastic mesh tubes on both the front face and the rear face of the bath brush, it is necessary to pass the tie string through the perforations of the handle and the plastic mesh tubes. Such process is quite difficult. In comparison with the conventional bath brush, the bath brush of the present invention can be directly made with two spongy bath bodies on both the front face and the rear face of the handle. Therefore, a considerable processing time is saved.

The bath brush of the present invention is made without using any fixing member so that the number of the components of the bath brush is reduced. This meets the global trend toward energy saving and carbon reduction.

The bath mesh materials can selectively have different colors to vary the colors of the bath mesh materials on both the front face and the rear face of the bath brush. For example, in FIG. 3, the semispherical bodies 32, 32′ , 32″ have different colors to enliven and beautify the appearance of the bath brush.

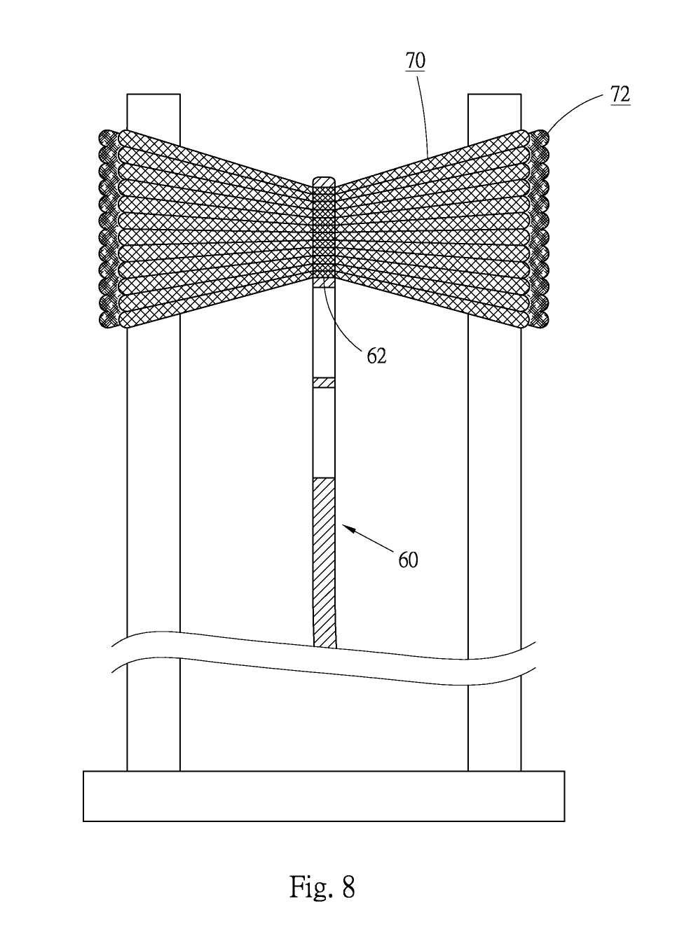

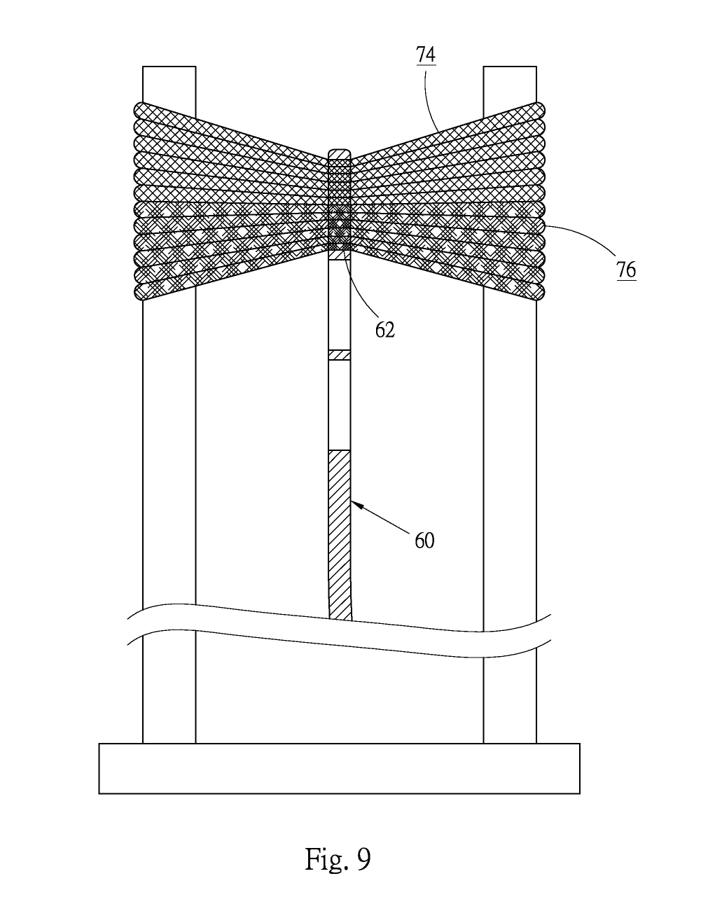

It should be noted that when manufacturing the bath brush of the present invention, alternatively, two plastic mesh tubes can be passed through each installation hole 62 of the handle 60 as shown in FIGS. 8 and 9. In FIG. 8, two mesh tubes 70, 72 are passed through one installation hole 62 with the mesh tube 70 nested in the mesh tube 72. Alternatively, in FIG. 9, two mesh tubes 74, 76 are passed through one installation hole 62 in upper and lower positional relationship. In both cases, the bath brush as shown in FIG. 1 can be made. The mesh tubes may have different colors.

The above embodiments are only used to illustrate the present invention, not intended to limit the scope thereof. Many modifications of the above embodiments can be made without departing from the spirit of the present invention.

What is claimed is:

1. A bath brush comprising:
a handle having a front half section as an installation section, the installation section being formed with at least two installation holes arranged along a length of the handle; and
at least two elastic bath mesh materials made of elastic plastic mesh tubes, the number of the elastic bath mesh materials being at least equal to that of the installation holes, the bath mesh materials being ball-shaped, each of the bath mesh materials having two spongy semispherical bodies and a pass-through section connected between the two semispherical bodies;
the bath mesh material is directly secured to the handle of itself without using any fixing member, the pass-through section of each of bath mesh materials being directly positioned in the installation hole with the two semispherical bodies respectively positioned on a front face and a rear face of the handle, the semispherical bodies being hindered from passing through the installation hole.

2. The bath brush as claimed in claim 1, wherein the lateral sides of the two semispherical bodies of the bath mesh material together enclose the handle.

3. The bath brush as claimed in claim 1, wherein the pass-through section of each of the bath mesh materials is positioned in the installation hole in slightly tight and elastic contact with a wall of the installation hole.

4. The bath brush as claimed in claim 2, wherein the pass-through section of each of the bath mesh materials is positioned in the installation hole in slightly tight and elastic contact with a wall of the installation hole.

5. The bath brush as claimed in claim 1, wherein the semispherical bodies of the bath mesh materials are respectively positioned on the front and rear faces of the handle and one after another arranged along the length of the handle without any gap between each two adjacent semispherical bodies.

6. The bath brush as claimed in claim 2, wherein the semispherical bodies of the bath mesh materials are respectively positioned on the front and rear faces of the handle and one after another arranged along the length of the handle without any gap between each two adjacent semispherical bodies.

7. The bath brush as claimed in claim 3, wherein the semispherical bodies of the bath mesh materials are respectively positioned on the front and rear faces of the handle and one after another arranged along the length of the handle without any gap between each two adjacent semispherical bodies.

8. The bath brush as claimed in claim 1, wherein the ball-shaped bath mesh materials are arranged along the length of the handle to form an elongated soft bath means.

9. The bath brush as claimed in claim 2, wherein the ball-shaped bath mesh materials are arranged along the length of the handle to form an elongated soft bath means.

10. The bath brush as claimed in claim 1, wherein a top of the handle is enclosed in an uppermost bath mesh material of the bath mesh materials.

11. The bath brush as claimed in claim 2, wherein a top of the handle is enclosed in an uppermost bath mesh material of the bath mesh materials.

12. The bath brush as claimed in claim 3, wherein a top of the handle is enclosed in an uppermost bath mesh material of the bath mesh materials.

13. The bath brush as claimed in claim 6, wherein a top of the handle is enclosed in an uppermost bath mesh material of the bath mesh materials.

14. The bath brush as claimed in claim 1, wherein the installation holes are elongated holes, circular holes, elliptic holes or polygonal holes.

15. The bath brush as claimed in claim 1, wherein at least two of the bath mesh materials have different colors.

16. The bath brush as claimed in claim 1, wherein the number of the elastic bath mesh materials is equal to that of the installation holes, each of the installation holes is installed with one bath mesh material.

17. The bath brush as claimed in claim 1, wherein at least one of the installation holes is installed with two the bath mesh materials.

18. A manufacturing method for a bath brush, comprising steps of:
(1) preparing a handle, which is formed with at least two installation holes;
(2) preparing at least two elastic plastic mesh tubes with a certain length;
(3) directly passing at least one plastic mesh tube through each of the installation holes of the handle to position two sides of the plastic mesh tube on a front face and a rear face of the handle respectively;
(4) extending the plastic mesh tube in a radial direction; and
(5) releasing the plastic mesh tube from the extended state to make the two sides of the plastic mesh tube become two spongy semispherical bodies respectively, the semispherical bodies being respectively positioned on the front and rear faces of the handle to form a ball-shaped elastic bath mesh material having a pass-through section connected between the two semispherical bodies, the pass-through section being positioned in the installation hole of the handle, the semispherical bodies being hindered from passing through the installation hole, whereby the elastic bath mesh material is directly secured to the handle of itself.

19. The manufacturing method as claimed in claim 18, wherein the lateral sides of the two semispherical bodies of the bath mesh material together enclose the handle.

20. The manufacturing method as claimed in claim 18, wherein the pass-through section of each of the bath mesh materials is positioned in the installation hole in slightly tight and elastic contact with a wall of the installation hole.
